(19) United States
(12) Patent Application Publication
(10) Pub. No.: US 2022/0371717 A1
(43) Pub. Date: Nov. 24, 2022

(54) Cabin And Parachute For Balloon

(71) Applicant: Iwaya Giken Inc., Sapporo-Shi (JP)

(72) Inventor: Keisuke IWAYA, Sapporo-shi (JP)

(21) Appl. No.: 17/692,261

(22) Filed: Mar. 11, 2022

(30) Foreign Application Priority Data
Mar. 16, 2021 (JP) 2021-042616

(51) Int. Cl. B64B 1/40; B64D 17/78

(52) U.S. Cl. CPC B64B 1/40; B64D 17/78

(57) ABSTRACT

The invention provides an inexpensive means of transporting people and objects to altitudes of 10,000 meters or more. Flying System 1 has Balloon 11, Suspension Lines 12 hanging downwards from Balloon 11, and Cabin 13 attached to the lower ends of Suspension Lines 12. The main body of Cabin 13 consists of laminated walls that include a fiber-reinforced plastic layer that keeps Cabin 13 watertight and airtight and also serves to maintain the shape of Cabin 13, an ultra-violet-rays blocking layer that reduces the amount of ultra-violet-rays transmitted into Cabin 13, an insulation layer that reduces the amount of heat conducted from the inside to the outside of Cabin 13, and an adhesive layer that enters and seals a crack or hole in the fiber-reinforced plastic layer when the crack or hole appears. The side walls of the main body of Cabin 13 have two hatches located opposite each other.

### TECHNICAL FIELD

The present invention relates to technology for flying a person(s) and object(s) by a balloon.

### BACKGROUND ART

Known in the art is a technology that allows people to move in the air by flying by use of a balloon a cabin containing the people. For example, Patent Document 1 proposes a manned drone with a configuration in which a main body of the drone containing a person is suspended by a balloon and flown.

### PRIOR ART DOCUMENT

### Patent Document

Patent Document 1: JP2020-97345A

### SUMMARY OF THE INVENTION

### Problem to be Solved by the Invention

Although a structure of a gas balloon is relatively simple, a gas balloon can fly from ground level to an altitude of about 50,000 meters. The inventor of this application conceived the idea of using a gas balloon to inexpensively transport people and objects at altitudes of 10,000 meters or more.

The invention provides an inexpensive means of transporting people and objects at altitudes of 10,000 meters or more.

### Means for Solving the Problem

The present invention includes, as a first aspect, a cabin flown by a balloon comprising: a main body with a wall forming an airtight housing space, the wall having a belt-shaped reinforced portion that is thicker than an area surrounding the reinforced portion.

The present invention includes, as a second aspect, a cabin according to the first aspect, wherein the reinforced portion and the portion of the wall adjacent to the reinforced portion are integrally formed.

The present invention includes, as a third aspect, a cabin according to the first aspect or the second aspect, wherein the reinforced portion and the portion of the wall adjacent to the reinforced portion are integrally formed fiber-reinforced plastic.

The present invention includes, as a fourth aspect, a cabin flown by a balloon comprising: a post suspended by the balloon; a plate-like body attached to the post and expanding in a direction perpendicular to a direction of extension of the post; and a main body forming an airtight housing space with a wall attached to the post.

The present invention includes, as a fifth aspect, a cabin according to the fourth aspect, wherein at least a part of the plate-like body forms a floor of the main body.

The present invention includes, as a sixth aspect, a cabin according to any one of the first aspect to the fifth aspect, wherein the wall of the main body is formed by a laminate including a layer that enters and seals a crack or hole when the crack or hole appears in the wall of the main body.

The present invention includes, as a seventh aspect, a cabin according to the sixth aspect, wherein the laminate includes an ultra-violet-rays blocking layer that reduces an amount of ultra-violet-rays transmitted from an outside to an inside of the main body.

The present invention includes, as an eighth aspect, a cabin according to the sixth aspect or the seventh aspect, wherein the laminate includes a layer of fiber-reinforced plastic.

The present invention includes, as a ninth aspect, a cabin according to any one of the sixth aspect to the eighth aspect, wherein the laminate includes an insulation layer that reduces a conduction of heat from an inside to an outside of the main body.

The present invention includes, as a tenth aspect, a cabin according to any one of the first aspect to the ninth aspect, comprising: plural hatches including two hatches located opposite each other in the wall of the main body.

The present invention includes, as an eleventh aspect, a cabin according to the tenth aspect, wherein each of the plural hatches has a polycarbonate lid.

The present invention includes, as a twelfth aspect, a cabin according to any one of the first aspect to the eleventh aspect, comprising: a securing mechanism that secures a crew member to the main body.

The present invention includes, as a thirteenth aspect, a cabin according to any one of the first aspect to the twelfth aspect, comprising: a parachute to be released downward from the main body, wherein the parachute has an umbrella body that expands by a force received from fluid and captures the fluid, one or more cables connecting the umbrella body and the main body, and a weight attached to the umbrella body.

The present invention includes, as a fourteenth aspect, a cabin according to any one of the first aspect to the thirteenth aspect, comprising: a ballast tank; a ballast discharge system that discharges ballast from the ballast tank; a gas discharge system that discharges lightweight gas from an air sac of the balloon; an altimeter that measures an altitude of the main body; and a controller that causes the ballast discharge device to discharge ballast when an altitude measured by the altimeter is lower than a first threshold altitude, and causes the gas discharge device to discharge lightweight gas when an altitude measured by the altimeter is higher than a second threshold altitude.

The present invention includes, as a fifteenth aspect, a cabin according to any one of the first aspect to the fourteenth aspect, comprising: an operating member located inside of the main body, the operating member being moved by a crew member; and an operated member located outside of the main body, the operated member moving in conjunction with a movement of the operating member.

The present invention includes, as a sixteenth aspect, a cabin according to any one of the first aspect to the fifteenth aspect, comprising: a first member movably disposed inside of the main body; and a second member located outside of the main body, magnetically connected to the first member through the wall of the main body, and moving in conjunction with a movement of the first member.

The present invention includes, as a seventeenth aspect, a cabin according to any one of the first aspect to the fifteenth aspect, comprising: a first member movably disposed inside of the main body; and a second member located outside of the main body, magnetically connected to the first member through the wall of the main body, and disconnected from the first member in response to a movement of the first member.

The present invention includes, as a eighteenth aspect, a cabin according to any one of the first aspect to the fifteenth aspect, comprising: a first member disposed inside of the main body; and a second member located outside of the main body, and magnetically connected to the first member through the wall of the main body; wherein at least one of the first member and the second member has an electromagnet, and a connection between the first member and the second member is disconnected when magnetic force of the electromagnet decreases.

The present invention includes, as a nineteenth aspect, a cabin according to any one of the first aspect to the eighteenth aspect, comprising: a carbon dioxide absorber that absorbs carbon dioxide from air in the main body.

The present invention includes, as a twentieth aspect, a cabin according to the nineteenth aspect, comprising: a carbon dioxide densitometer that measures a concentration of carbon dioxide in the air in the main body; and a controller that controls an operation of the carbon dioxide absorber based on a measurement result of the carbon dioxide densitometer.

The present invention includes, as a twenty-first aspect, a cabin according to any one of the first aspect to the twentieth aspect, comprising: a gas cylinder opening/closing device that opens and closes a gas cylinder containing gas including oxygen; an oxygen densitometer that measures a concentration of oxygen in the air in the main body; and a controller that controls an operation of the gas cylinder opening/closing device based on a measurement result of the oxygen densitometer.

The present invention includes, as a twenty-second aspect, a cabin according to any one of the first aspect to the twenty-first aspect, comprising: a condensation-promoting member that conducts heat from an inside of the main body to an outside of the main body and promotes condensation of water vapor in air in the main body.

The present invention includes, as a twenty-third aspect, a cabin according to any one of the first aspect to the twenty-second aspect, comprising: plural lids arranged in layers on the wall of the main body, each of which plural lids opens and closes independently in response to an operation of a crew member in the main body.

The present invention includes, as a twenty-fourth aspect, a cabin according to any one of the first aspect to the twenty-third aspect, comprising: a photographing device placed in a position to shoot the main body.

The present invention includes, as a twenty-fifth aspect, a cabin according to any one of the first aspect to the twenty-fourth aspect, comprising a space dosimeter that measures space dose in the main body; and a storage device that stores data indicating a measurement result of the space dosimeter.

The present invention includes, as a twenty-sixth aspect, a cabin according to any one of the first aspect to the twenty-fifth aspect, wherein a shape of at least part of the main body is a sphere, a part of a sphere, a cylinder, or a part of a cylinder.

The present invention includes, as a twenty-seventh aspect, a parachute comprising: an umbrella body that expands by a force received from fluid and captures the fluid, one or more cables connecting the umbrella body and an object falling from the air toward water, and a weight attached to the umbrella body.

The present invention includes, as a twenty-eighth aspect, a cabin flown by a balloon comprising: a main body with a wall forming an airtight housing space, a first member movably disposed inside of the main body; and a second member located outside of the main body, magnetically connected to the first member through the wall of the main body, and moving in conjunction with a movement of the first member.

The present invention includes, as a twenty-ninth aspect, a cabin flown by a balloon comprising: a main body with a wall forming an airtight housing space, a first member movably disposed inside of the main body; and a second member located outside of the main body, magnetically connected to the first member through the wall of the main body, and disconnected from the first member in response to a movement of the first member.

The present invention includes, as a thirtieth aspect, a cabin flown by a balloon comprising: a main body with a wall forming an airtight housing space, a first member disposed inside of the main body; and a second member located outside of the main body, and magnetically connected to the first member through the wall of the main body; wherein at least one of the first member and the second member has an electromagnet, and a connection between the first member and the second member is disconnected when magnetic force of the electromagnet decreases.

### BRIEF EXPLANATION OF THE DRAWINGS

FIG. 1 shows an overall configuration of a flying system according to an exemplary embodiment of the present invention.

FIG. 2 shows an oblique top view of a cabin according to the exemplary embodiment of the present invention.

FIG. 3 shows an example of a structure of a laminate that constitutes a main body of the cabin according to the exemplary embodiment of the present invention.

FIG. 4 shows components placed inside the main body of the cabin according to the exemplary embodiment of the present invention.

FIG. 5 shows how an anchor parachute according to the exemplary embodiment of the present invention mitigates an impact of the flying system when it lands on water.

FIG. 6 shows a mechanism for exhausting lightweight gas from a balloon according to the exemplary embodiment of the present invention.

FIG. 7 shows an example of a configuration of a plug for an operating cable according to the exemplary embodiment of the present invention.

FIG. 8 shows an example of a shape for cabin according to a modification of the exemplary embodiment of the present invention.

FIG. 9 shows an example of a configuration of a cabin according to a modification of the exemplary embodiment of the present invention.

FIG. 10 shows an example of a configuration of a cabin according to a modification of the exemplary embodiment of the present invention.

FIG. 11 shows a mechanism for exhausting lightweight gas from a balloon according to a modification of the exemplary embodiment of the present invention.

FIG. 12A shows an example of a configuration of a magnetic coupling operation mechanism according to a modification of the exemplary embodiment of the present invention.

FIG. 12B shows an example of a configuration of a magnetic coupling operation mechanism according to a modification of the exemplary embodiment of the present invention.

FIG. 12C shows an example of a configuration of a magnetic coupling operation mechanism according to a modification of the exemplary embodiment of the present invention.

FIG. 12D shows an example of a configuration of a magnetic coupling operation mechanism according to a modification of the exemplary embodiment of the present invention.

FIG. 13 shows an oblique top view of a cabin according to a modification of the exemplary embodiment of the present invention.

FIG. 14 shows a top view of a cabin according to a modification of the exemplary embodiment of the present invention.

FIG. 15 shows a side view of a cabin according to a modification of the exemplary embodiment of the present invention.

FIG. 16 shows a bottom view of a cabin according to a modification of the exemplary embodiment of the present invention.

FIG. 17 shows an example of an area of a reinforced portion of the main body of the cabin according to a modification of the exemplary embodiment of the present invention.

FIG. 18 shows a cross section of the main body of the cabin according to a modification of the exemplary embodiment of the present invention cut in a horizontal plane.

FIG. 19 shows a cross section of the main body of the cabin according to a modification of the exemplary embodiment of the present invention cut in a vertical plane.

### MODES FOR CARRYING OUT THE INVENTION

### Exemplary Embodiment

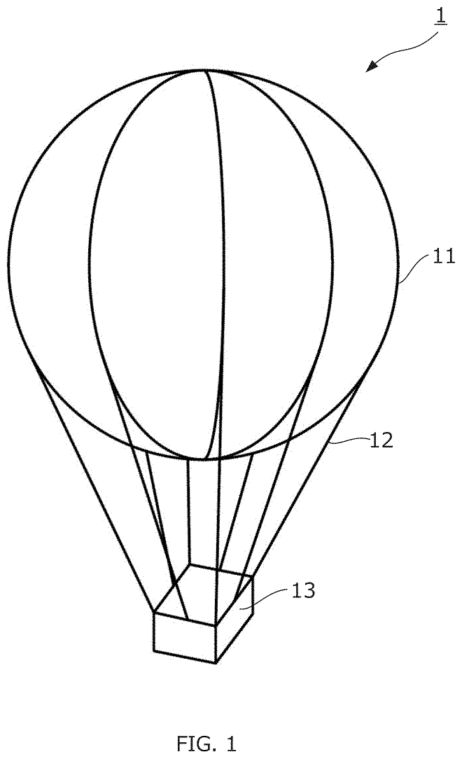

FIG. 1 shows an overall configuration of Flying System 1 according to an exemplary embodiment of the present invention. Flying System 1 comprises Balloon 11, Suspension Lines 12 hanging downwards from Balloon 11, and Cabin 13 suspended by Suspension Lines 12.

Balloon 11 comprises an air sac that is an airtight bag-shaped member and a gas lighter than air such as helium gas or hydrogen gas (hereinafter referred to as “lightweight gas”) filled inside the air sac. Balloon 11 flies by buoyancy generated by the lightweight gas in the air. Suspension Lines 12 are cables for suspending Cabin 13 by Balloon 11. Cabin 13 is a large watertight and airtight container that accommodates one or more persons (crew members) and objects and that is flown by Balloon 11.

Since Cabin 13 rises to an altitude of about 20,000 meters above the ground, the crew members inside Cabin 13 may wear space suits in case Cabin 13 cannot be kept airtight due to an accident.

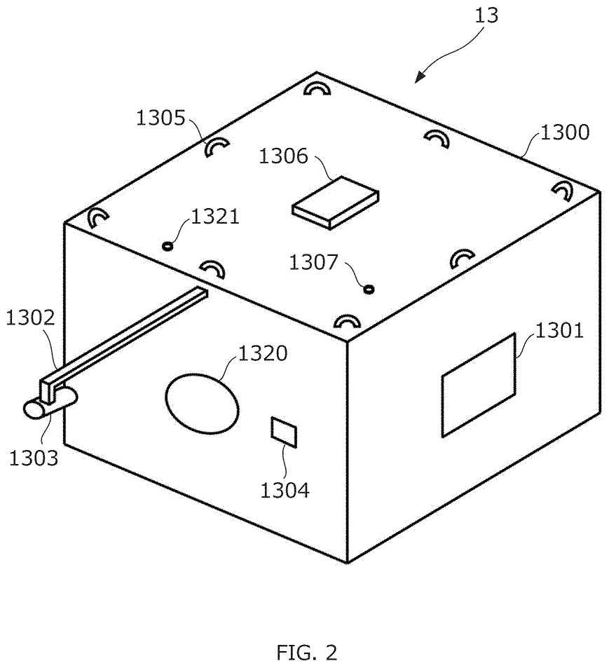

FIG. 2 shows an oblique top view of Cabin 13. Cabin 13 comprises Main Body 1300, Hatches 1301, Arm 1301 extending outward from Main Body 1300, Photographing Device 1303 mounted near the tip of Arm 1302, Multi-door 1304, Hooks 1305, Device Box 1306, Plug 1307, Window 1320, and On-off Valve 1321. In the following description, Main Body 1300 and Cabin 13 may not be distinguished so long as the description is clear.

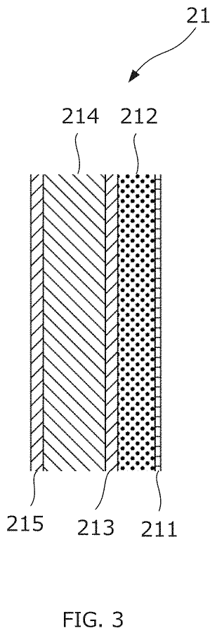

Main Body 1300 is a container constituting the main body of Cabin 13. FIG. 3 shows an example of a structure of Laminate 21 that constitutes a wall of Main Body 1300. Laminate 21 consists of Ultra-Violet-Rays Blocking Layer 211, Insulation Layer 212, Adhesive Layer 213, Fiber-reinforced Plastic Layer 214 and Adhesive Layer 215 from the outside (right side of FIG. 3).

Ultra-Violet-Rays Blocking Layer 211 reflects or absorbs ultra-violet-rays toward the inside of Cabin 13, and reduces an amount of ultra-violet-rays transmitted from the outside to the inside of Cabin 13. Insulation Layer 212 has low thermal conductivity and reduces a conduction of heat from the inside to the outside of Main Body 1300. For example, lightweight materials such as styrene foam, urethane foam, etc. are suitable as materials for Insulation Layer 212. Insulation Layer 212 also functions as a cushioning material to soften an impact when Cabin 13 lands on the ground or on water, and as a floating body to keep Cabin 13 above the water surface if Cabin 13 lands on water.

Adhesive Layer 213 and Adhesive Layer 215 are layers of high viscosity material. Adhesive Layer 213 and Adhesive Layer 215 stop air leakage from the inside to the outside of Cabin 13 by entering and sealing a crack or hole appearing in Fiber-reinforced Plastic Layer 214. Materials employed for Adhesive Layer 213 and Adhesive Layer 215 include, for example, viscous resins, tar, etc.

Fiber-reinforced Plastic Layer 214 is a layer of fiber-reinforced plastic that serves to keep Cabin 13 watertight and airtight and to maintain the shape of Cabin 13. Any glass fiber-reinforced plastic, carbon fiber-reinforced plastic, etc. may be used as material of Fiber-reinforced Plastic Layer 214. Glass fiber-reinforced plastics are superior to carbon fiber-reinforced plastic in their ability to transmit radio waves.

The configuration of Laminate 21 is not limited to that illustrated in FIG. 3. For example, the order of the layers comprising Laminate 21 may be changed. The number of layers comprising Laminate 21 may be increased or decreased. For example, in addition to insulation Layer 212, another insulation layer may be added to Laminate 21. Either one of Adhesive Layer 213 or Adhesive Layer 215 may be omitted.

Hatch 1301 is a door that can be opened and closed, and is used for the crew members to enter and exit Cabin 13. When Hatch 1301 is closed, the inside of Cabin 13 is sealed watertight and airtight with sealing material. A main body of Hatch 1301 is made of plastic, such as polycarbonate, for example.

Cabin 13 has a pair of two hatches 1301 positioned opposite each other on the walls of the Main Body 1300. For example, Hatch 1301 is also located on the far left side of Main Body 1300, which is a blind spot in FIG. 2. Thus, with two Hatches 1301 positioned opposite each other on the walls of the Main Body 1300, when the Cabin 13 lands on water, at least one Hatch 1301 will always be above the water surface, regardless of an orientation of Cabin 13 on water.

Photographing Device 1303 is a camera for shooting the crew members in Cabin 13 looking out from Cabin 13 and Hatch 1301, for example, with the earth in the background. Photographing Device 1303 can be operated wirelessly or wired from a controller located in Cabin 13. Image data representing video or still image captured by Photographing Device 1303 is transmitted wirelessly or by wire to the controller in Cabin 13 and stored by the controller. Arm 1302 maintains the positional relationship between Cabin 13 and Photographing Device 1303 so that Photographing Device 1303 can shoot Cabin 13.

Multi-door 1304 is a mechanism for ejecting Objects from inside Cabin 13 to outside Cabin 13. Multi-door 1304 has plural lids arranged in layers, each of which opens and closes independently in response to an operation performed by a crew member in Cabin 13.

One use of Multi-door 1304 could be, for example, scattering of funeral ashes. The following is an example of an operation for scattering funeral ashes when Multi-Door 1304 has two lids arranged in layers. A crew member inside Cabin 13 opens the inner lid with the outer lid closed and place funeral ashes in the space between the two lids. Then, the crew member closes the inner lid and opens the outer lid. While Balloon 11 is rising, Cabin 13 is subject to a strong wind from top to bottom. Therefore, when the outer lid is opened, the funeral ashes are scattered by the wind into the space outside Cabin 13. Cabin 13 may be provided with a discharge mechanism that forces objects in the space between the two lids to be discharged from the space when the inner lid is closed and the outer lid is open, in response to an operation made by the crew member in Cabin 13. After the discharge of the funeral ashes from the space between the lids of Multi-door 1304 to the space outside Cabin 13 is complete, the crew member closes the outer lid of Multi-door 1304. Multi-door 1304 may have a structure where all lids are not open at the same time, i.e., one or more lids is always closed.

Hooks 1305 are located on the outer surface of the ceiling or on the outer surface of the side wall near the ceiling. Each of Hooks 1305 is connected to one of Suspension Lines 12.

Device Box 1306 is a container that houses devices such as a measurement device that measures physical quantities outside Main Body 1300, a communication device that performs wireless data communications, etc. A measurement device housed in Device Box 1306 may include a barometer, a thermometer, an ultra-violet-ray dosimeters, a space dosimeter, Global Navigation Satellite System (GNSS) units, etc. A communication device housed in Device Box 1306 may include a communication device that performs data communication with a communication device on the ground, a communication device that performs data communication with the controller in Cabin 13, a communication device that performs data communication with a gas discharge device in Balloon 11, etc.

Plug 1307 is a member positioned to plug a hole through Laminate 21 in the ceiling of Cabin 13 or in the side wall near the ceiling of Cabin 13. Plug 1307 has a hole through which an operating cable, which is a cable that is used for a crew member in Cabin 13 to manually open and close an exhaust port for exhausting lightweight gas of Balloon 11, passes. Plug 1307 keeps Cabin 13 watertight and airtight, while allowing the operating cable to move so that the crew member can open and close the exhaust port of Balloon 11 by pulling down and releasing the operating cable.

Window 1320 is a window for the crew members in Cabin 13 to look out of Cabin 13. A main body of Window 1320 is made of a plastic that transmits light such as transparent polycarbonate. Window 1320 may have an ultra-violet-rays blocking layer on the inside or outside of its main body. Window 1320 may have a visible light blocking plate that can be opened and closed by a crew member in Cabin 13 to prevent visible light from passing from outside Cabin 13 to inside Cabin 13.

On-off Valve 1321 is a valve that opens when an air pressure in Cabin 13 exceeds a threshold value to exhaust air from inside Cabin 13 to outside Cabin 13.

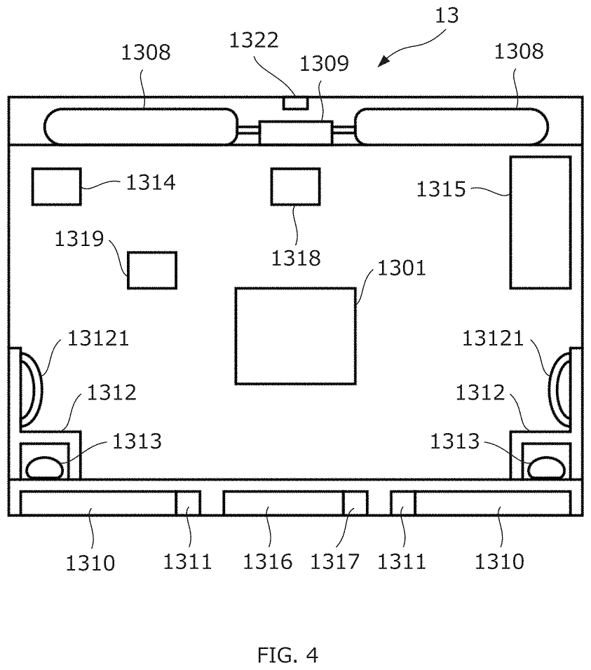

FIG. 4 shows components placed inside Main Body 1300. The positions and numbers of the components shown in FIG. 4 are examples and may be changed as necessary.

Flying System 1 comprises, in Main Body 1300, Gas Cylinders 1308, Gas Cylinder Opening/closing Device 1309, Ballast Tanks 1310, Ballast Discharge Device 1311, Seats 1312, Emergency Parachutes 1313, Condensation Promoting Plate 1314, Carbon Dioxide Absorber 1315, Anchor Parachute 1316, Anchor Parachute Ejection System 1317, Device Box 1318, Valve Opening/closing Device 1322 and Controller 1319.

Gas Cylinders 1308 are cylinders that contain gas containing Oxygen (including oxygen-only gas). Gas Cylinder Opening/closing Device 1309 opens and closes Gas Cylinders 1308.

Ballast Tanks 1310 are tanks that contain ballast (grain or powder such as sand, or liquid such as water) to adjust a weight of Cabin 13. Each of Ballast Tanks 1310 has a discharge port in its underside that can be opened and closed. The discharge port of Ballast Tank 1310 is opened and closed by Ballast Discharge Device 1311. In other words, Ballast Discharge Device 1311 discharges ballast from Ballast Tanks 1310. The discharge port of Ballast Tanks 1310 is also opened and closed by a ballast discharge port opening/closing mechanism that is not shown in FIG. 4. The ballast discharge port opening/closing mechanism is located in Cabin 13 and opens/closes the ballast discharge port in response to an operation performed by a crew member on an operating member such as opening/closing lever, etc. When the discharge port of Ballast Tanks 1310 is opened, ballast in Ballast Tanks 1310 is discharged and a weight of Cabin 13 is reduced. As a result, the fierce to raise Flying System 1 increases.

Seats 1312 (an example of a securing mechanism) are seats for the crew members in Cabin 13 to sit on in case of impact when Flying System 1 lands on the ground or on water. Therefore, Cabin 13 is equipped with a number of Seats 1312 corresponding to a number of crew members that can be accommodated in Cabin 13. Seats 1312 are fixed to Main Body 1300. Each of Seats 1312 is equipped with Seat Belt 13121. Seat Belt 13121 secures a crew member seated in Seat 1312 to Cabin 13.

Emergency Parachutes 1313 are parachutes that are used when the crew members in Cabin 13 must be ejected out of Cabin 13 because of an unexpected accident. Therefore, Cabin 13 is equipped with a number of Emergency Parachutes 1313 corresponding to a number of crew members that can be accommodated in Cabin 13.

Condensation Promoting Plate 1314 (an example of a condensation promoting member) is a component that reduces water vapor in the air in Cabin 13 by promoting condensation of water vapor in the air in Cabin 13. Condensation Promoting Plate 1314 is made of a material with high thermal conductivity and conducts heat from the inside of Cabin 13 to the outside of Cabin 13. As a result, a temperature of a portion of Condensation Promoting Plate 1314 exposed in Cabin 13 becomes lower than a temperature of the air in Cabin 13, and water vapor in Cabin 13 that touches Condensation Promoting Plate 1314 is cooled to become water or ice. Materials used for Condensation Promoting Plate 1314 include metals such as copper and aluminum.

Carbon Dioxide Absorber 1315 absorbs carbon dioxide from the air in Main Body 1300. Carbon Dioxide Absorber 1315 is, for example, a device that absorbs carbon dioxide contained in the air in Cabin 13 by bringing the air into contact with alkaline solution such as amine (a device using a chemical absorption method), but it may be based on any other method.

Anchor Parachute 1316 is a parachute that expands in water when Flying System 1 lands on water to reduce a velocity of Flying System 1 mainly in a vertical direction and mitigate an impact of the water landing.

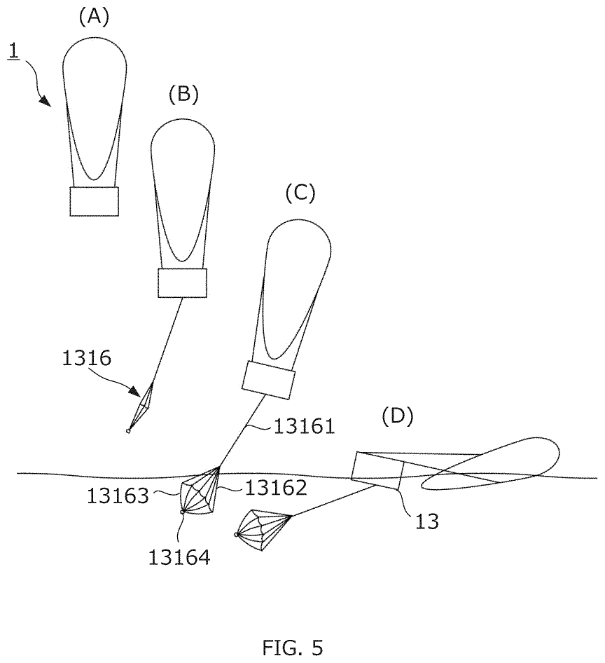

FIG. 5 shows how Anchor Parachute 1316 mitigates an impact of Flying System 1 when it lands on water. FIG. 5(A) shows Flying System 1 returning to near sea level. When Cabin 13 falls to a predetermined altitude, Anchor Parachute Ejection System 1317 located on the underside of Cabin 13 ejects Anchor Parachute 1316 downward. FIG. 5(B) shows Anchor Parachute 1316 just after it is ejected from Cabin 13.

Anchor Parachute 1316 comprises Cable 13161, Cables 13162, Umbrella Body 13163 and Weight 13164. One end of Cable 13161 is connected to the underside of Cabin 13 and the other end of Cable 13161 is connected to Cables 13162. One end of each Cable 13162 is connected to Cable 13161 and the other end of each Cable 13162 is connected to Umbrella Body 13163. Weight 13164 is attached to a zenith of Umbrella Body 13163. Unlike an ordinary parachute, the Anchor Parachute 1316 performs its function in a generally upside-down position.

Anchor Parachute 1316 ejected from Cabin 13 hangs below Cabin 13 due to the weight of Weight 13164, as shown in FIG. 5(B). When an altitude of Flying System 1 decreases further and Umbrella Body 13163 reaches the water surface, the weight of Weight 13164 causes Umbrella Body 13163 to submerge into the water. A horizontal force applied to Umbrella Body 13163 by Cable 13161 and Cables 13162 causes Umbrella Body 13163 to expand under the force of water (an example of fluid). FIG. 5(C) shows Umbrella Body 13163 open in water.

When Umbrella Body 13163 expands in water, Umbrella Body 13163 captures the water, and a resistance force generated by Umbrella Body 13163 mainly in the horizontal direction increases. As a result, Cabin 13 is subjected to force from Umbrella. Body 13163 via Cables 13162 and Cable 13161 that prevents Cabin 13 from moving forward, and a horizontal speed of Cabin 13 decreases. Then, Cabin 13 lands on the water surface. FIG. 5(D) shows Cabin 13 landing on water.

Device Box 1318 is a container that contains one or more devices such as devices that measure physical quantities in Main Body 1300, etc. A device contained in Device Box 1306 may include, but is not limited to, a barometer, a thermometer, an ultra-violet-ray dosimeter, a cosmic dosimeter, a hygrometer, an oxygen densitometer, a carbon dioxide densitometer, etc.

Valve Opening/closing Device 1322 opens and closes On-off Valve 1321.

Controller 1319 (an example of a controller) is a device that controls devices in Cabin 13, and it also functions as a man-machine interface between the devices in Cabin 13 and the crew members of Cabin 13. Controller 1319 may be realized by a computer with a processor operating in accordance with an application program stored in a memory of the computer.

Processes performed by Controller 1319 may include, but are not limited to, the following:

(1) a process to control operations of Carbon Dioxide Absorber 1315 based on measurement results of a carbon dioxide densitometer in Device Box 1318 to prevent a carbon dioxide concentration in Cabin 13 from rising above a threshold value,
(2) a process to control operations of Gas Cylinder Opening/closing Device 1309 based on measurement results of an oxygen densitometer in Device Box 1318 to prevent an oxygen concentration in Cabin 13 from falling below a threshold value,
(3) a process to notify the crew members ley sound, display, etc., when measurement results of a barometer in Device Box 1318 indicate an abnormal drop in atmospheric pressure,
(4) a process to notify the crew members by sound, display, etc., when measurement results of an ultra-violet-ray dosimeter in Device Box 1318 indicate that an amount of ultra-violet-rays exceeds a threshold value,
(5) a process to instruct Photographing Device 1303 to start and stop shooting in response to an operation of a crew member, to receive image data representing images shot by Photographing Device 1303 from Photographing Device 1303 while Photographing Device 1303 is in operation, and to store the image data,
(6) a process to calculate an altitude of Cabin 13 based on measurement results of a GNSS unit or a barometer in Device Box 1306, and to notify the crew members by sound, display, etc., when the calculated altitude reaches a threshold value,
(7) a process to calculate an altitude of Cabin 13 based on measurement results of the GNSS unit or the barometer in Device Box 1306, and to instruct Anchor Parachute Ejection System 1317 to eject Anchor Parachute 1316 when the calculated altitude reaches a threshold value,
(8) a process to instruct a gas discharge device to discharge lightweight gas of Balloon 11 in response to an operation of a crew member,
(9) a process to instruct Ballast Discharge Device 1311 to discharge ballast in Ballast Tanks 1310 in response to an operation of a crew member,
(10) a process to calculate an altitude of Cabin 13 based on measurement results of the GNSS unit or the barometer in Device Box 1306 when a crew member specifies a target altitude, and to perform a feedback control by instructing the gas discharge device to discharge lightweight gas or Ballast Discharge Device 1311 to discharge ballast so that the calculated altitude approaches the altitude specified by the crew member,
(11) a process to store measurement results of measurement devices in Device Box 1306 or Device Box 1318, and
(12) a process to instruct Valve Opening/closing Device 1322 to open On-off Valve 1321 when measurement results of the barometer in Device Box 1318 indicate that an air pressure in Cabin 13 exceeds a first threshold value, to instruct Valve Opening/closing Device 1322 to close On-off Valve 1321 when measurement results of the barometer in the Device Box 1318 indicate that an air pressure in Cabin 13 falls below a second threshold value.

In the above-explained process (1), Controller 1319 plays a role of a controller that controls an operation of a carbon dioxide absorber based on a measurement result of a carbon dioxide densitometer.

In the above-explained process (2), Controller 1319 plays a role of a controller that controls an operation of a gas cylinder opening/closing device based on a measurement result of an oxygen densitometer.

In the above-explained processes (6), (7) and (10), Controller 1319 plays a role of an altimeter that measures an altitude of Main Body 1300.

In the above-explained process (10), Controller 1319 plays a role of a controller that causes a ballast discharge device to discharge ballast when an altitude measured by an altimeter is lower than a first threshold altitude, and causes a gas discharge device to discharge lightweight gas when an altitude measured by the altimeter is higher than a second threshold altitude.

Some of the measurement results stored in a storage device of Controller 1319 in the above-explained process (11) are used to ascertain a health burden suffered by the crew members, etc. For example, measurement results of the space dosimeter in Device Box 1318 indicate an amount of cosmic radiation that the crew members were exposed to. Therefore, the measurement results of the space dosimeter stored in the storage device of Controller 1319 are used to manage cosmic radiation exposure of the crew members.

Controller 1319 can communicate with a communication device on the earth wirelessly via a communication device in Device Box 1306. Therefore, Controller 1319 can also perform at least some of the above-explained processes e.g., the processes (8) to (10) for adjusting an altitude of Balloon 11) in accordance with instructions transmitted wirelessly from a communications device on the earth.

Measurement results obtained by Controller 1319 from the measurement devices in Device Box 1306 or Device Box 1318, information on a state of Cabin 13 determined based on the measurement results, etc., are transmitted to a communication device on the earth via the communication device in Device Box 1306. Therefore, people on the earth can receive information on Flying System 1 in flight in real time.

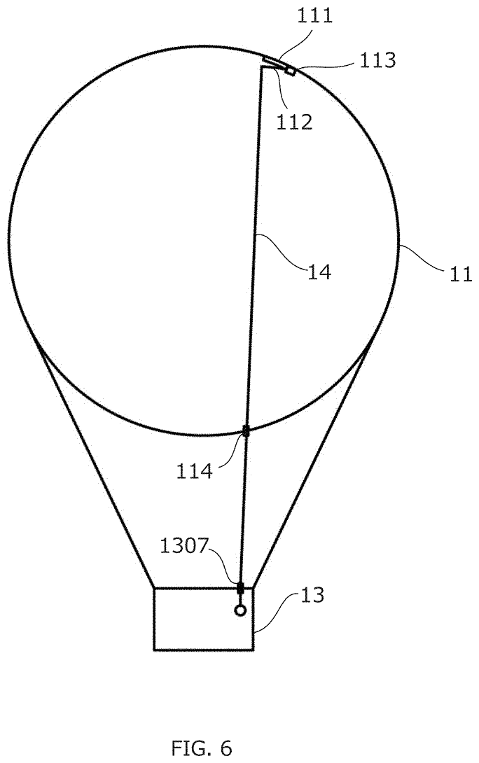

As previously mentioned, Balloon 11 is equipped with an exhaust port, and when the exhaust port is opened, lightweight gas in Balloon 11 is discharged. The following is a description of an example of mechanism for exhausting lightweight gas. FIG. 6 shows a mechanism for exhausting lightweight gas from Balloon 11.

Balloon 11 has Exhaust Port 111 near its zenith. Exhaust Port 111 is usually closed by Lid 112 that is pressurized in the closing direction. Lid 112 is an example of an operated member that is located outside Main Body 1300 and moves in conjunction with a movement of an operating member operated by a crew member. Lid 112 is designed to open in the inward direction of Balloon 11. Gas Discharge Device 113 that opens and closes Lid 112 is located near Lid 112. Gas Discharge Device 113 opens and closes Lid 112 in accordance with instructions from Controller 1319 to discharge lightweight gas from the air sac of Balloon 11 and to stop discharging lightweight gas from the air sac of Balloon 11.

Lid 112 can also be opened and closed by manual operations of the crew members in Cabin 13 in case of failure of Gas Discharge Device 113, etc. One end of Operating Cable 14 for the manual operations is connected to Lid 112. Operating Cable 14 is arranged so that its other end reaches inside Cabin 13 through Plug 114 located near the nadir of Balloon 11 and Plug 1307 located on the ceiling or the side wall near the ceiling of Cabin 13. The end of Operating Cable 14 in Cabin 13 is an example of an operating member that is located inside of Main Body 1300 and moved by a crew member.

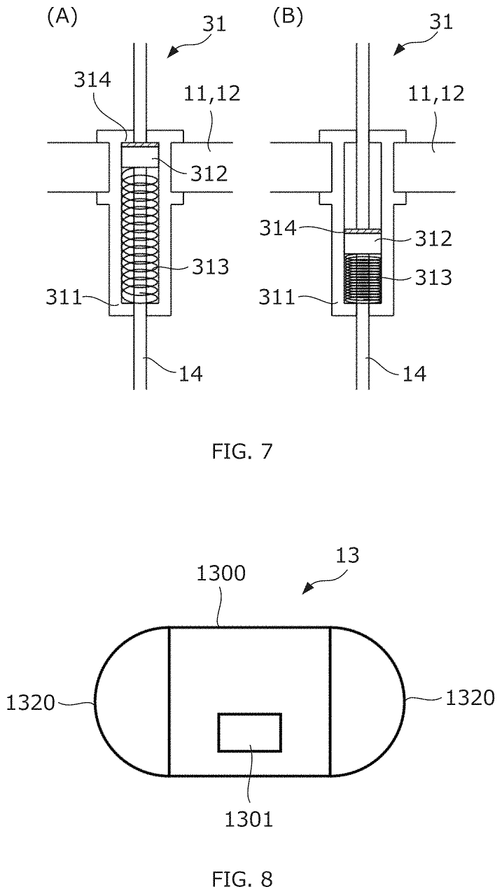

Plug 114 allows for the movement of Operating Cable 14 while keeping Balloon 11 airtight. Plug 1307 allows for the movement of Operating Cable 14 while keeping Cabin 13 airtight. FIG. 7 shows an example of a configuration of Plug 114 and Plug 1307. Plug 114 and Plug 1307 are hereinafter collectively referred to as Plug 31 for Operating Cable 14.

Plug 31 comprises Cylindrical Member 311, Column Member 312, Power Spring 313 and Sealing Member 314. Cylindrical Member 311 is mounted to penetrate the air sac of Balloon 11 or Laminate 21 of Cabin 13. Column Member 312, Power Spring 313 and Sealing Member 314 are located in Cylindrical Member 311. Sealing Member 314 is donut-shaped and is located on the side of Column Member 312 that is not in contact with Power Spring 313.

Column Member 312 has a hole penetrating Column Member 312 in the axial direction of its cylindrical shape. With Operating Cable 14 passing through the hole, Column Member 312 and Operating Cable 14 are fixed together by adhesive or other means. A gap between the hole in Column Member 312 and Operating Cable 14 is hermetically sealed by the adhesive or other means.

Operating Cable 14, Plug 114 and Plug 31 described above constitute an exhaust port opening/closing mechanism that opens and closes Lid 112 that closes Exhaust Port 111 of Balloon 11.

FIG. 7(A) shows Plug 31 in a state where Operating Cable 14 is not pulled. When Operating Cable 14 is not pulled, Column Member 312 is pressed against Cylindrical Member 311 by Power Spring 313 with Sealing Member 314 between Column Member 312 and Cylindrical Member 311. In the state shown in FIG. 7(A), Sealing Member 314 keeps Balloon 11 or Cabin 13 airtight.

FIG. 7(B) shows Plug 31 in a state where Operating Cable 14 is pulled. When Operating Cable 14 is pulled, Column Member 312 moves downward, and Power Spring 313 is shrunk. As Column Member 312 moves, a gap between Cylindrical Member 311 and Column Member 312 is sealed by lubricant, and the lubricant keeps Balloon 11 or Cabin 13 airtight. Even if the lubricant in the gap between Cylindrical Member 311 and Column Member 312 is insufficient and gas leaks out through the gap, a flow rate of leaked gas is minute and a time during which Operating Cable 14 is pulled is usually short, so there is no substantial impact.

### Modifications

The above-described Flying System 1 is an exemplary embodiment of the present invention, and may be modified in various ways. Following are examples of modifications of the above-described embodiment. Two or more of the above-described embodiment and the following modifications may be combined.

(1) The shape, size, arrangement, etc. of the components of Flying System 1 shown in the figures are examples, and they may be modified in various ways.

For example, in Flying System 1 shown in FIG. 1, each of Suspension Lines 12 hanging downward from the outside of the air sac of Balloon 11 is independently connected to Cabin 13. Alternatively, two or more of Suspension Lines 12 may be bundled together at the bottom and connected to Cabin 13 together. Further alternatively all of Suspension Lines 12 may be connected to one separate suspension line and connected to Cabin 13 via the suspension line.

For example, Flying System 1 shown in FIG. 1 comprises one Balloon 11. Alternatively, Flying System 1 may comprise plural Balloons 11.

For example, Cabin 13 shown in FIG. 2 is rectangular in shape as a whole. The shape of Cabin 13 may be modified in various ways. FIG. 8 shows an example of Cabin 13 with a non-rectangular shape. Cabin 13 shown in FIG. 8 has Main Body 1300 with a cylindrical shape and two Windows 1320 with a hemispherical shape arranged to close each of the two openings of Main Body 1300. In Main Body 1300, Hatch 1301 with a shape curved in the same way as Main Body 1300 is provided. As in this example, if a shape of at least part of Main Body 1300, Hatch 1301, Window 1320, etc., that serve to maintain the shape of Cabin 13, is a sphere, a part of a sphere, a cylinder, or a part of a cylinder, it can achieve the required strength with comparatively light weight.

A number of Hatches 1301 may be other than two, and a number of Windows 1320 may be more than one.

Instead of the Fiber-reinforced Plastic Layer 214 comprising Laminate 21 shown in FIG. 3, a layer of material other than fiber-reinforced plastic, such as light metal (aluminum, duralumin, magnesium alloy, etc.), may be employed.

A number of crew members who can be seated in each of Seats 1312 at one time may be more than one. Seat 1312 is an example of a securing mechanism that secures a crew member to Main Body 1300, and any other type of securing mechanism may be employed. For example, instead of Seat 1312, a mechanism that secures a crew member lying on the floor with a belt or the like may be employed. The member that secures a crew member to Main Body 1300 is not limited to a belt, and any other type of member that secures a crew member to Main Body 1300, such as a locking bar covered with cushioning material or the like, may be employed.

(2) in the above-described embodiment, Main Body 1300 is composed of Laminate 21. Materials comprising Main Body 1300 are not limited to Laminate 21. For example, Main Body 1300 may be composed of Laminate 21 and a frame that reinforces Laminate 21. In such a case, it is desirable for the frame to be made of lightweight material such as aluminum. At least part of Main Body 1300 may be composed of a sheet of material whose shape is maintained by the frame, instead of Laminate 21.
(3) In the above-described embodiment, a load of components contained in Cabin 13 is mainly supported by Main Body 1300 that is container-shaped. Alternatively, Cabin 13 may comprise one or more posts suspended by Balloon 11 via Suspension Lines 12, and a plate-like body attached to the one or more posts and expanding in a direction perpendicular to a direction of extension of the one or more posts, and Main Body 1300 may be attached to the one or more posts. In this case, Main Body 1300 forms an airtight housing space with walls attached to the posts.

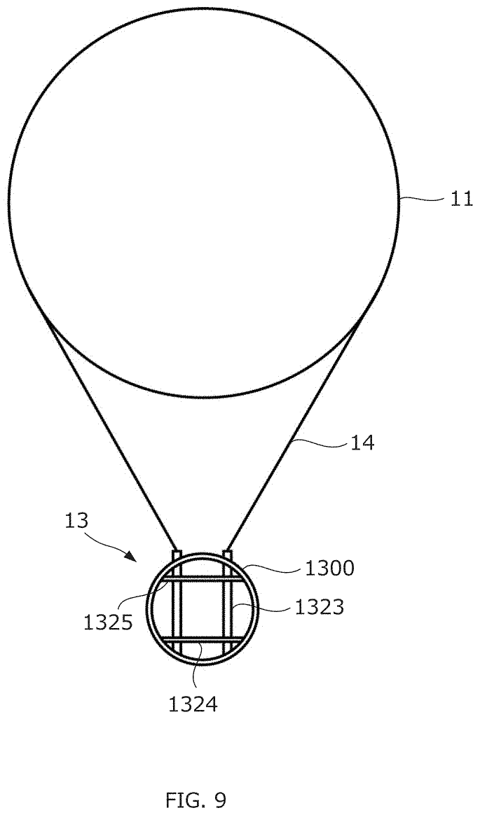

FIG. 9 shows an example of a configuration of Cabin 13 according to this modification. Cabin 13 shown in FIG. 9 comprises Posts 1323, Floorboard 1324, Shelf Board 1325 and Main Body 1300. Posts 1323 are connected to Suspension Lines 12 and suspended from Balloon 11 via Suspension Lines 12. Each of Floorboard 1324 and Shelf Board 1325 is a plate-like body attached to Posts 1323 and expanding horizontally. Main Body 1300 is attached to Posts 1323 and houses Floorboard 1324 and Shelf Board 1325. According to Cabin 13 shown in FIG. 9, most of the load of objects and crew members in Cabin 13 on Floorboard 1324 or Shelf Board 1325 is not applied to Main Body 1300. Therefore, compared to Main Body 1300 in the above-described embodiment, a strength required for Main Body 1300 in this modification is smaller. As a result, Main Body 1300 can be made lighter and the overall weight of Cabin 13 can be reduced.

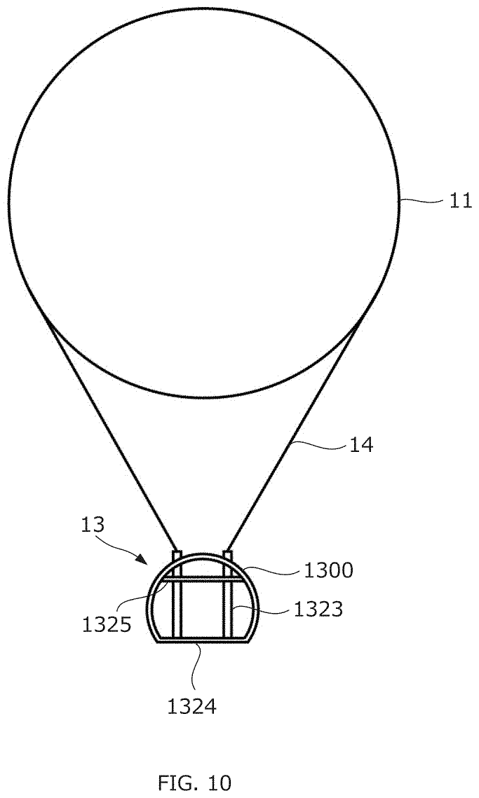

Floorboard 1324 (an example of at least a part of a plate-like body) may form a floor of Main Body 1300. FIG. 10 shows an example of a configuration of Cabin 13 according to this modification. In Cabin 13 shown in FIG. 10, Floorboard 1324 is integrated with Main Body 1300.

(4) In the above-described embodiment, Operating Cable 14, one end of which is connected to Lid 112 that opens and closes Exhaust Port 111 of Balloon 11 and the other end of which reaches inside Main Body 1300, is employed as a mechanism to move a component outside Main Body 1300 in response to an operation of a crew member in Main Body 1300. Similar mechanisms may be used for discharging ballast from Ballast Tanks 1310, ejecting Anchor Parachute 1316, etc.
(5) In the above-described embodiment, the lower end of Operating Cable 14 reaches inside Cabin 13 through Plug 1307 as shown in FIG. 6. Alternatively, the lower end of Operating Cable 14 may be located outside Cabin 13, and Operating Cable 14 outside Cabin 13 may be pulled in response to an operation of a crew member in Cabin 13.

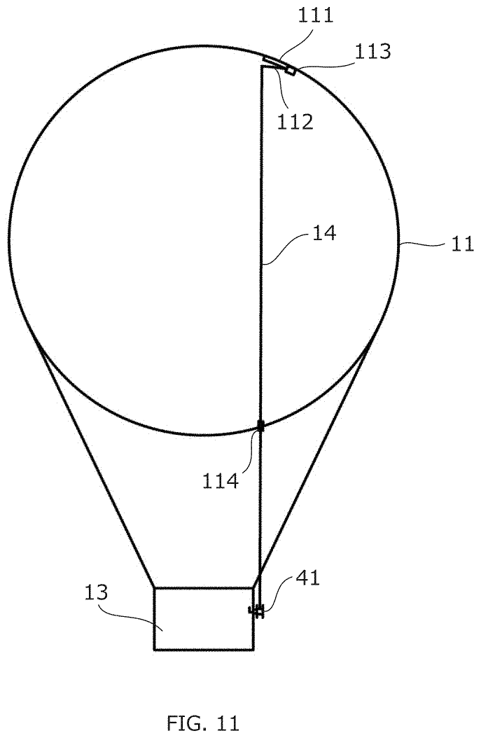

FIG. 11 shows an example of an exhaust port opening/closing mechanism in which the lower end of Operating Cable 14 is located and pulled outside Cabin 13. According to the exhaust port opening/closing mechanism shown in FIG. 11, the lower end of Operating Cable 14 is wound up outside Cabin 13 by Magnetic Coupling Operating Mechanism 41, and Lid 112 is pulled by Operating Cable 14 to open Exhaust Port 111 of Balloon 11.

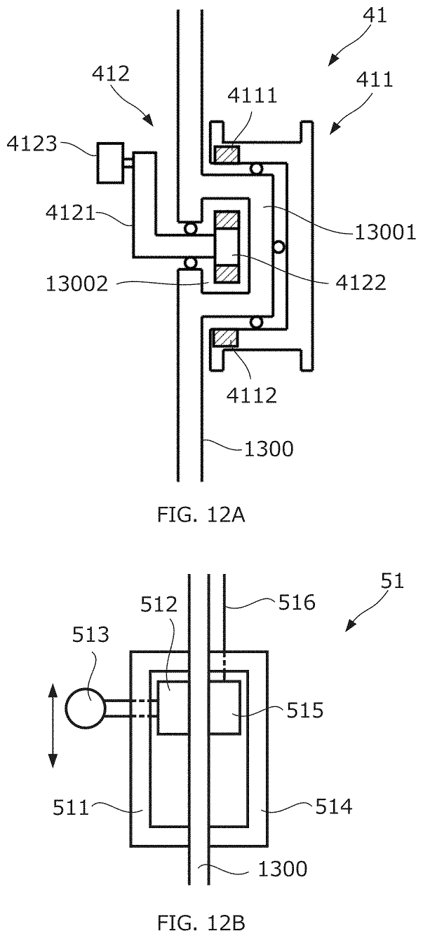

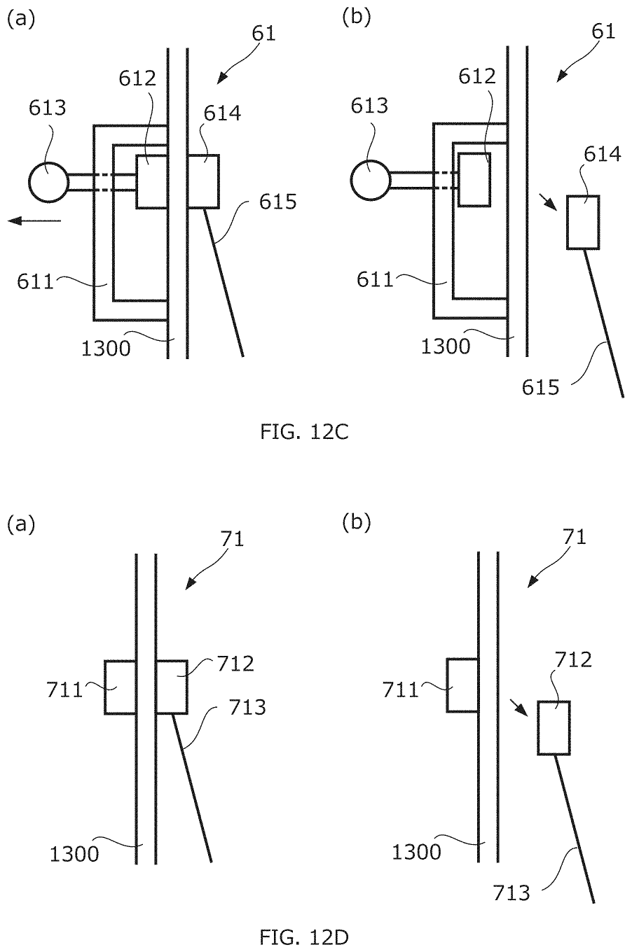

FIG. 12A shows an example of a configuration of Magnetic Coupling Operating Mechanism 41. In this modification, a side wall of Main Body 1300 has Protruding Member 13001 that protrudes outward. The inside of Protruding Member 13001 is hollow, forming Housing Space 13002.

Magnetic Coupling Operating Mechanism 41 has Spool 411 that winds and unwinds Operating Cable 14 and Handle 412 that rotates Spool 411. Spool 411 and Handle 412 are magnetically connected through a wall of Main Body 1300. Handle 412 is an example of a first member movably disposed inside of Main Body 1300. Spool 411 is an example of a second member located outside of Main Body 1300, magnetically connected to the first member through the wall of Main Body 1300, and moving in conjunction with a movement of the first member.

Spool 411 is rotatably mounted around a left-right axis in FIG. 12A to cover the outside of Protruding Member 13001. Spool 411 has Magnet 4111 and Magnet 4112 at positions opposite each other across the cylindrical side of Protruding Member 13001. Magnet 4111 and Magnet 4112 have different polarities on the side facing Protruding Member 13001. For example, Magnet 4111 has N-pole on the side facing Protruding Member 13001 and Magnet 4112 has S-pole on the side facing Protruding Member 13001.

Handle 412 has Shaft 4121, Magnet 4122 and Knob 4123. Shaft 4121 is an L-shaped member and is attached to Main Body 1300, rotatable around the left-right axis in FIG. 12A, while partially accommodated in Housing Space 13002. Magnet 4122 is a disk-shaped magnet and is attached to the end of Shaft 4121 on the side housed in Housing Space 13002. Knob 4123 is attached to the end of Shaft 4121 that is not housed in Housing Space 13002. N-pole and S-pole of Magnet 4122 are aligned in the diameter direction of the disk shape. Knob 4123 is rotatably attached to shaft 4121 around the left-right axis in FIG. 12A.

S-pole of Magnet 4122 is magnetically attracted to Magnet 4111 through the wall of Main Body 1300. At the same time, N-pole of Magnet 4122 is magnetically attracted to Magnet 4112 through the wall of Main Body 1300. Therefore, when a crew member in Cabin 13 picks Knob 4123 to rotate Shaft 4121, Spool 411 rotates outside Cabin 13 as Magnet 4122 rotates. As a result, Operating Cable 14 is wound by Spool 411 or unwound from Spool 411.

According to the exhaust port opening/closing mechanism with the above configuration, there is no need to open a hole in Main Body 1300, and it is easy to keep the inside of Cabin 13 airtight and watertight.

A mechanism such as Spool 411 (an example of a first member) and Handle 412 (an example of a second member) described above, which are connected by magnetic force through the wall of Main Body 1300 and have a first member that moves inside Main Body 1300 and a second member that moves in conjunction with the movement of the first member, may be used for purposes other than opening and closing Exhaust Port 111 of Balloon 11.

For example, a mechanism similar to Magnetic Coupling Operating Mechanism 41 may be used for opening and closing an exhaust port of Ballast Tank 1310, ejecting Anchor Parachute 1316 or Emergency Parachute 1313, changing of position or posture of a device such as an antenna, a sensor and a photographing device located outside of Main Body 1300, emitting dye that facilitates for a user to find Balloon 11 after landing on the earth, etc.

The first member and the second member of Magnetic Coupling Operating Mechanism 41 described above rotate around an axis. A direction of movement of the first member and the second member is not limited to the rotational direction. For example, the first member and the second member may move in a linear direction.

FIG. 12B shows an example of a configuration of Magnetic Coupling Operating Mechanism 51 with the first and second members that move in a linear direction. Magnetic Coupling Operating Mechanism 51 has Box 511, Magnet 512 (an example of the first member) and Knob 513. Box 511 is located inside Main Body 1300. Magnet 512 is located in Box 511. Knob 513 penetrates Box 511 through a slit in Box 511. One end of Knob 513 is connected to Magnet 512, while the other end is exposed to the outside of Box 511. A crew member can move Knob 513 in the vertical direction in FIG. 12B. In response to the operation of the crew member, Magnet 512 moves in the vertical direction in FIG. 12B.

Magnetic Coupling Operating Mechanism 51 has Box 514, Magnet 515 (an example of the second member) and Operating Cable 516. Box 514 is located outside of Main Body 1300. Magnet 515 is located in Box 514. Operating Cable 516 penetrates Box 514 through a hole in Box 514. One end of Operating Cable 516 is connected to Magnet 515 and the other end of Operating Cable 516 is connected to the component being operated.

Magnet 512 and Magnet 515 are connected by magnetic force through the wall of Main Body 1300. Therefore, when Magnet 512 moves in response to an operation to Knob 513 made by a crew member, Magnet 515 moves in conjunction with the movement of Magnet 512. As Magnet 515 moves, Operating Cable 516 moves. For example, if the crew member moves Knob 513 downward in FIG. 12B, Operating Cable 516 is pulled downward.

Either Magnet 512 or Magnet 515 of Magnetic Coupling Operating Mechanism 51 may be replaced by a magnetic material other than a magnet such as iron.

In the magnetic coupling operating mechanisms shown in FIGS. 12A and 12B, the second member located outside Main Body 1300 moves in conjunction with a movement of the first member located inside Main Body 1300. Alternatively, a configuration in which a magnetic connection between the first and second members is broken when the first member moves may be adopted.

Magnetic Coupling Operating Mechanism 61 shown in FIG. 12C has Box 611, Magnet 612 (an example of the first member) and Knob 613. Box 611 is located inside Main Body 1300. Magnet 612 is located in Box 611. Knob 613 penetrates Box 611 through a hole in Box 611. One end of Knob 613 is connected to Magnet 612, while the other end of Knob 613 is exposed to the outside of Box 611. A crew member can move Knob 613 in the left-right direction in FIG. 12C. In response to the operation to Knob 613 by the crew member, Magnet 612 moves in the left-right direction in FIG. 12C.

Magnetic Coupling Operating Mechanism 61 has Magnet 614 (an example of the second member) and Cable 615. Magnet 614 is located outside of Main Body 1300. One end of Cable 615 is connected to Magnet 614. The end of Cable 615 that is not connected to Magnet 614 is connected to an object that is to be released from Main Body 1300 such as a bag containing ballast, a parachute, etc. After the object is released from Main Body 1300, the connection between the object and Flying System 1 may be maintained, for example, by a cable other than Cable 615.

When Flying System 1 flies from the ground, Knob 613 is pushed to the right and Magnet 612 is in contact with the inner surface of Main Body 1300, while a magnetic connection is maintained with Magnet 614, which is in contact with the outer surface of Main Body 1300 as shown in FIG. 12C(a). When a crew member pulls Knob 613 to the left during flight or after landing on the earth, the distance between Magnet 612 and Magnet 614 increases and the magnetic connection between Magnet 612 and Magnet 614 is broken. As a result, the object is released from Main Body 1300 as shown in FIG. 12C(b).

Either Magnet 612 or Magnet 614 of Magnetic Coupling Operating Mechanism 61 may be replaced by a magnetic material other than a magnet such as iron.

The magnets of Magnetic Coupling Operating Mechanism 41, 51 or 61 may be either permanent magnets or electromagnets.

In Magnetic Coupling Operating Mechanism 61, the magnetic connection between the first and second members is broken as the first member moves. Alternatively, at least one of the first member and the second member is an electromagnet, and the magnetic connection between the first member and the second member is dissociated when a magnetic force generated by the electromagnet decreases.

Magnetic Coupling Operating Mechanism 71 shown in FIG. 12D has Magnet 711 (an example of the first member), Magnet 712 (an example of the second member) and Cable 713. Magnet 711 is located inside Main Body 1300. Magnet 712 is located outside of Main Body 1300. One end of Cable 713 is connected to Magnet 712. For example, Magnet 711 is an electromagnet and Magnet 712 is a permanent magnet.

The end of Cable 713 that is not connected to Magnet 712 is connected to an object to be released from Main Body 1300. After the object is released from Main Body 1300, the connection between the object and Flying System 1 may be maintained, for example, by a cable other than Cable 713.

When Flying System 1 flies from the ground, a predetermined amount of electric power is supplied to Magnet 711 from a power supply unit (not shown in FIG. 12D), and a magnetic connection is maintained between Magnet 711 and Magnet 712 as shown in FIG. 12D(a). When a crew member operates the power supply unit to reduce the amount of electric power supplied to Magnet 711 during flight or after landing on the earth, the magnetic three generated by Magnet 711 is reduced. Accordingly, the magnetic connection between Magnet 711 and Magnet 712 is dissociated. As a result, the object is released from Main Body 1300 as shown in FIG. 12D(b).

Magnet 712 may be replaced with a magnetic material other than a magnet such as iron.

The operation to the first member of Magnetic Coupling Operating Mechanism 41, 51, 61 or 71 may be made by a device such a robot instead of a crew member. When the operation to the first member is made by a device, the device may be wirelessly controlled from the earth. When a predetermined condition is met, e.g., when a predetermined time has elapsed, when Cabin 13 has reached a predetermined altitude, etc., the operation by the device to the first member may be made automatically without human intervention.

(6) in the above-described embodiment, Ultra-Violet-Rays Blocking Layer 211 of Laminate 21 is independent layer from the other layers. Alternatively, one or more layers of Laminate 21 other than Ultra-Violet-Rays Blocking Layer 211 may function as Ultra-Violet-Rays Blocking Layer 211. For example, ultra-violet-rays blocking material may be mixed with plastic of Fiber-reinforced Plastic Layer 214 before the plastic is harden so that Fiber-reinforced Plastic Layer 214 can play the role of Ultra-Violet-Rays Blocking Layer 211.
(7) Main Body 1300 may form an airtight housing space with a wall that has a belt-shaped reinforced portion that is thicker than an area surrounding the reinforced portion.

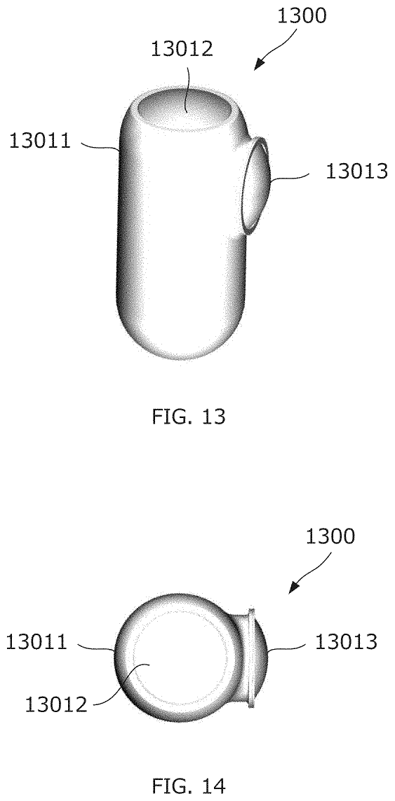

An example of a configuration of Main Body 1300 according to this modification is described below. FIG. 13 shows an oblique top view of Main Body 1300 according to this modification. FIG. 14 shows a top view of Main Body 1300 according to this modification. FIG. 16 shows a bottom view of Main Body 1300 according to this modification.

Main Body 1300 has Container 13011, Door 13012 and Window 13013. Door 13012 is retractably attached to Container 13011. Window 13013 is located on the side wall of Container 13011. Each of Container 13011 and Door 13012 is made of integrally molded fiber-reinforced plastic. The type of fiber-reinforced plastic may be glass fiber-reinforced plastic, carbon fiber-reinforced plastic, or a composite of both. Window 13013 is made of polycarbonate or other plastic, which allows light from the outside to penetrate into Container 13011.

Container 13011 is hollow and forms a housing space for crew members and objects. Container 13011 has an opening to be closed by Door 13012. When Door 13012 seals the opening of Container 13011, the housing space in Container 13011 is kept airtight.

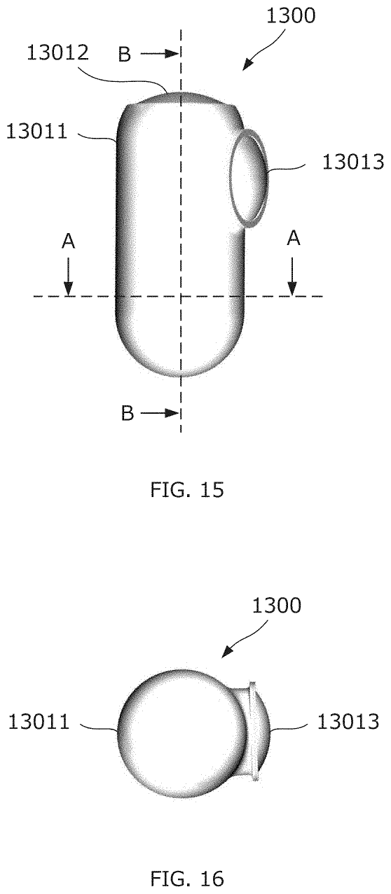

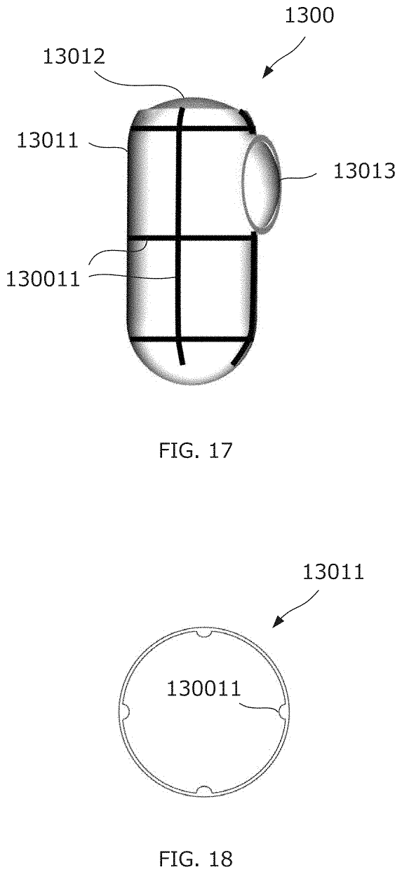

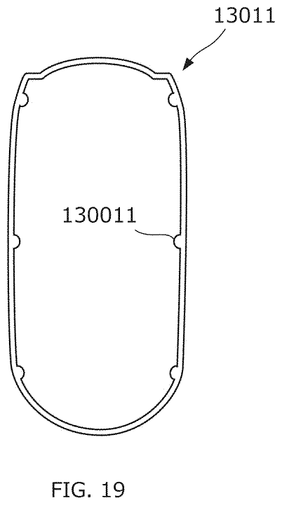

Container 13011 has a belt-shaped reinforced portion that is thicker than an area surrounding the reinforced portion. FIG. 17 shows an example of an area of Reinforced Portion 130011 in Container 13011. FIG. 18 shows a cross section of Container 13011 cut in a horizontal plane seen in a direction shown by Arrows A in FIG. 15. FIG. 19 shows a cross section of Container 13011 cut in a vertical plane viewed in a direction shown by Arrows Bin FIG. 15.

Most of the load of objects and crew members inside or outside of Container 13011 is supported by Reinforced Portion 130011. Suspension Lines 12 are connected to Reinforced Portion 130011. In other words, Reinforced Portion 130011 plays a role of frames of Container 13011.

A thickness of Reinforced Portion 130011 may be as thin as possible under the condition that it is strong enough to support the load applied to Container 13011. A thickness of the parts of Container 13011 other than Reinforced Portion 130011 may be as thin as possible under the condition that it is strong enough to withstand the force generated by the pressure difference between the inside and outside of Container 13011.

According to Cabin 13 with Main Body 1300 of this modification, Cabin 13 can be made lighter than, for example, when the thickness of the wall of Container 13011 is constant.

Container 13011 may be made of material other than fiber-reinforced plastic, such as plastic other than fiber-reinforced plastics, light metals such as aluminum, etc.

In Container 13011 of this modification described above, Reinforced Portion 130011 and the portion of Container 13011 surrounding Reinforced Portion 130011 are integrally molded. Alternatively, Container 13011 may be manufactured by connecting the wall of Container 13011 and Reinforced Portion 130011, which are formed separately, by bonding, welding, welding, screwing, an engagement mechanism, etc.

Various methods of forming Container 13011 into one piece can be employed, depending on the material of Container 13011. For example, if the material is fiber-reinforced plastic, the hand layup method, spray-up method, SMC press method, RTM method, etc. may be employed. If the material is a non-fiber-reinforced plastic, an injection molding method, a 3D printer molding method, etc. may be employed. If the material is a light metal such as aluminum, for example, a casting method, a cutting method, etc. may be employed.

Reinforced Portion 130011 shown in FIGS. 18 and 19 is raised on the inside of Container 13011. Reinforced Portion 130011 may be raised on the outside of Container 13011 or both inside and outside of Container 13011.

1. A cabin flown by a balloon comprising:
a main body with a wall forming an airtight housing space, the wall having a belt-shaped reinforced portion that is thicker than an area surrounding the reinforced portion,
wherein the reinforced portion and a portion of the wall adjacent to the reinforced portion are integrally formed plastic or metal.

2. A cabin according to claim 1,
wherein the reinforced portion and the portion of the wall adjacent to the reinforced portion are integrally formed fiber-reinforced plastic.

3. A cabin according to claim I,
wherein the wall of the main body is formed by a laminate including a layer that enters and seals a crack or hole when the crack or hole appears in the wall of the main body.

4. A cabin according to claim 3,
wherein the laminate includes an ultra-violet-rays blocking layer that reduces an amount of ultra-violet-rays transmitted from an outside to an inside of the main body.

5. A cabin according to claim 3,
wherein the laminate includes a layer of fiber-reinforced plastic.

6. A cabin according to claim 3,
wherein the laminate includes an insulation layer that reduces a conduction of heat from an inside to an outside of the main body.

7. A cabin according to claim 1 comprising:
plural hatches including two hatches located opposite each other in the wall of the main body.

8. A cabin according to claim 7,
wherein each of the plural hatches has a polycarbonate lid.

9. A cabin according to claim 1 comprising:
a securing mechanism that secures a crew member to the main body.

10. A cabin according to claim 1 comprising:
a parachute to be released downward from the main body,
wherein the parachute has an umbrella body that expands by a force received from fluid and captures the fluid, one or more cables connecting the umbrella body and the main body, and a weight attached to the umbrella body.

11. A cabin according to claim 1 comprising:
a ballast tank;
a ballast discharge system that discharges ballast from the ballast tank;
a gas discharge system that discharges lightweight gas from an air sac of the balloon;
an altimeter that measures an altitude of the main body; and
a controller that causes the ballast discharge device to discharge ballast when an altitude measured by the altimeter is lower than a first threshold altitude, and causes the gas discharge device to discharge lightweight gas when an altitude measured by the altimeter is higher than a second threshold altitude.

12. A cabin according to claim 1 comprising:
an operating member located inside of the main body, the operating member being moved by a crew member; and
an operated member located outside of the main body, the operated member moving in conjunction with a movement of the operating member.

13. A cabin according to claim 1 comprising:
a first member movably disposed inside of the main body; and
a second member located outside of the main body, magnetically connected to the first member across the wall of the main body, and moving in conjunction with a movement of the first member.

14. A cabin according to claim 1 comprising:
a first member movably disposed inside of the main body; and
a second member located outside of the main body, magnetically connected to the first member across the wall of the main body, and disconnected from the first member in response to a movement of the first member.

15. A cabin according to claim 1 comprising:
a first member disposed inside of the main body; and
a second member located outside of the main body, and magnetically connected to the first member across the wall of the main body;
wherein
at least one of the first member and the second member has an electromagnet, and
a connection between the first member and the second member is disconnected when magnetic force of the electromagnet decreases.

16. A cabin according to claim 1 comprising:
a carbon dioxide absorber that absorbs carbon dioxide from air in the main body.

17. A cabin according to claim 16 comprising:
a carbon dioxide densitometer that measures a concentration of carbon dioxide in the air in the main body; and
a controller that controls an operation of the carbon dioxide absorber based on a measurement result of the carbon dioxide densitometer.

18. A cabin according to claim 1 comprising:
a gas cylinder opening/closing device that opens and closes a gas cylinder containing gas including oxygen;
an oxygen densitometer that measures a concentration of oxygen in the air in the main body; and
a controller that controls an operation of the gas cylinder opening/closing device based on a measurement result of the oxygen densitometer.

19. A cabin according to claim 1 comprising:
a condensation-promoting member that conducts heat from an inside of the main body to an outside of the main body and promotes condensation of water vapor in air in the main body.

20. A cabin according to claim 1 comprising:
plural lids arranged in layers on the wall of the main body, each of the plural lids opens and closes independently in response to an operation of a crew member in the main body.

21. A cabin according to claim 1 comprising:
a photographing device placed in a position to shoot the main body.

22. A cabin according to claim 1 comprising:
a space dosimeter that measures space dose in the main body; and
a storage device that stores data indicating a measurement result of the space dosimeter.

23. A cabin according to claim 1,
wherein a shape of at least part of the main body is a sphere, a part of a sphere, a cylinder, or a part of a cylinder.
